(19) United States
(12) Patent Application Publication
(10) Pub. No.: US 2015/0027565 A1
(43) Pub. Date: Jan. 29, 2015

(54) WATER SUPPLY MONITOR

(71) Applicant: Pairoj Vatanakorn, Tinley Park, IL (US)

(72) Inventor: Pairoj Vatanakorn, Tinley Park, IL (US)

(21) Appl. No.: 13/948,355

(22) Filed: Jul. 23, 2013

(51) Int. Cl. G08B 21/18; E03D 11/00

(52) U.S. Cl. CPC G08B 21/182; E03D 11/00
USPC 137/487.5; 340/606

(57) ABSTRACT

A water flow monitor for detecting water flow comprising: a control panel, where the control panel depicts control mechanisms associated with water flow monitoring; a pipe receptacle on a bottom side of the water flow monitor; a strap extending from the bottom, where the strap secures the water flow monitor to a water supply pipe; a plurality of time period settings, where a particular time period may be selected using the control panel; and an alarm, where the alarm alerts a user of continuous water flow over one of the time period settings. In an alternative embodiment, the water flow monitor connects in line with a water supply pipe, where water flow monitor provides both an alarm and a mechanism to actually cut the water supply off should the overflow parameters are met associated with the monitor.

### BACKGROUND OF THE INVENTION

1. Field of Invention

The present invention relates to a water supply meter for use with a conventional toilet.

2. Description of Related Art

Many times conventional toilets overflow unintentionally due to malfunctions related to the toilet and tank associated with the toilet. This overflow of water may occur undetected due to lack of notice. Occasionally individuals may leave their home for a period of days or in the case of commercial buildings many times no one may be in the building over a weekend period. If a malfunction should occur with a toilet while the toilet is unattended water damage in addition to increased water consumption will be experienced by the user. It is advantageous to monitor the flow of water that is supplied to a toilet in order to detect potential problems that may be occurring and to alert the user of any excessive water flow.

### SUMMARY OF THE INVENTION

The present invention relates to a water flow monitor for detecting water flow comprising: a control panel, where the control panel depicts control mechanisms associated with water flow monitoring; a pipe receptacle on a bottom side of the water flow monitor; a strap extending from the bottom, where the strap secures the water flow monitor to a water supply pipe; a plurality of time period settings, where a particular time period may be selected using the control panel; and an alarm, where the alarm alerts a user of continuous water flow over one of the time period settings. In an alternative embodiment, the water flow monitor connects in line with a water supply pipe, where water flow monitor provides both an alarm and a mechanism to actually cut the water supply off should the overflow parameters are met associated with the monitor.

### BRIEF DESCRIPTION OF DRAWINGS

FIG. 1 depicts a water flow monitor in accordance with the present invention.

FIG. 2 depicts use of the water flow monitor on a water supply to a toilet.

FIG. 3 depicts a second water flow monitor in accordance with the present invention.

FIG. 4 depicts use of the second water flow monitor in accordance with the present invention.

### DETAILED DESCRIPTION

The present invention relates to water flow monitors used to monitor the flow of water through a water supply directed to a toilet. The water flow monitor according to the present invention connect to the water supply line and provide control mechanisms to determine water flow through the water supply line. The monitors function in a manner associated with predetermined time period where water flow is monitored over a preset period of time. The water flow monitors further include alarm systems to alert the user of excessive water flow.

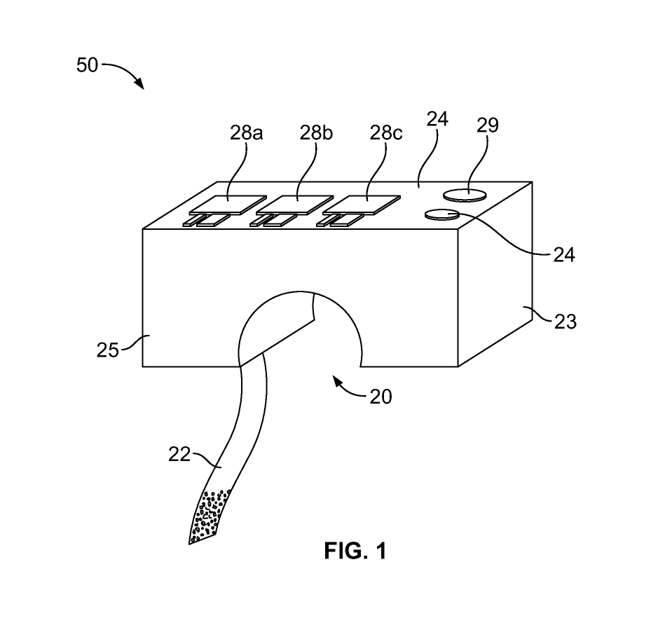

In reference to FIG. 1, a Water Flow Monitor 50 in accordance with the present invention is depicted. The Water Flow Monitor 50 includes a Control Panel 24 that depicts control mechanisms to provide water flow monitoring associated with the Monitor 50. The Water Flow Monitor 50 fits over a water flow supply line by inserting the water line into the Pipe Receptacle 20. The Pipe Receptacle 20 is provided on the bottom side of the Flow Monitor 50. A strap 22 is used to mount and support the Monitor 50 onto the water supply line. At the top side the Control Panel 24 includes settings to determine overflow time periods. In this particular monitor three settings are provided; a 6-minute setting 28a, a 8-minute setting 28b and a 10-minute setting 28c. A Reset Button 24 is also provided along with Control Panel 24. If excessive water flow is determined by the monitor, an Alarm 29 activates and provides a visual and audible alarm alerting the user of excessive water flow through the water supply.

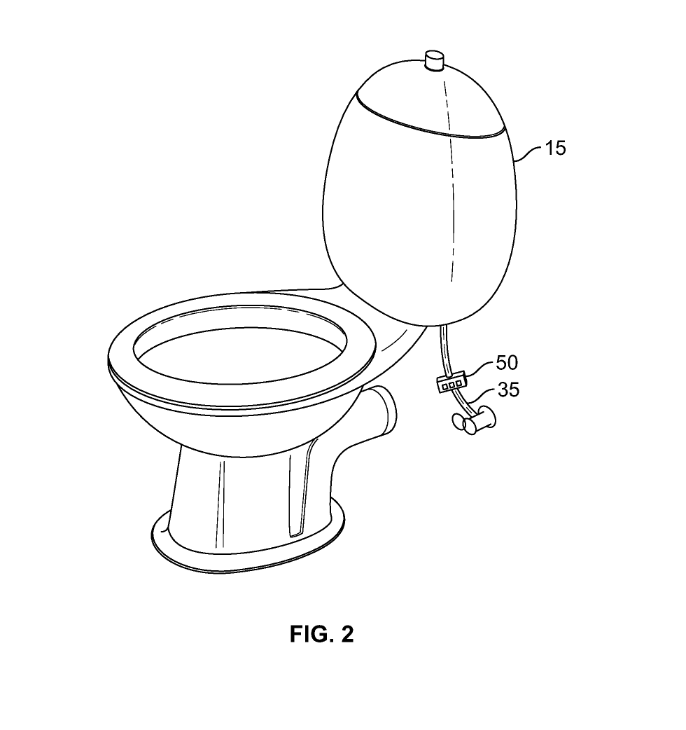

The water supply monitor with Flow Monitor 50 is depicted in FIG. 2 and used on a Water Supply Pipe 35. The Water Supply Pipe 35 supplies water to a Toilet 15 as shown in FIG. 2. The supply monitor can therefore provide alerts of any excessive water flow over a period of time. The alarm may be set as shown in FIG. 1 for 6-minute flow period, 8-minute flow period or 10-minute flow period. The user receives an alert and a signal if water continuously flows for the predetermined period of time.

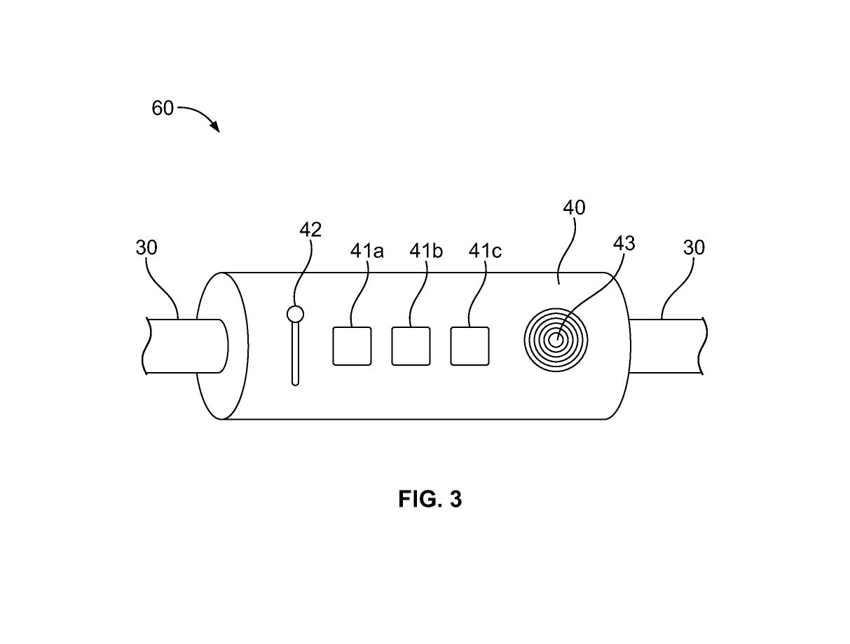

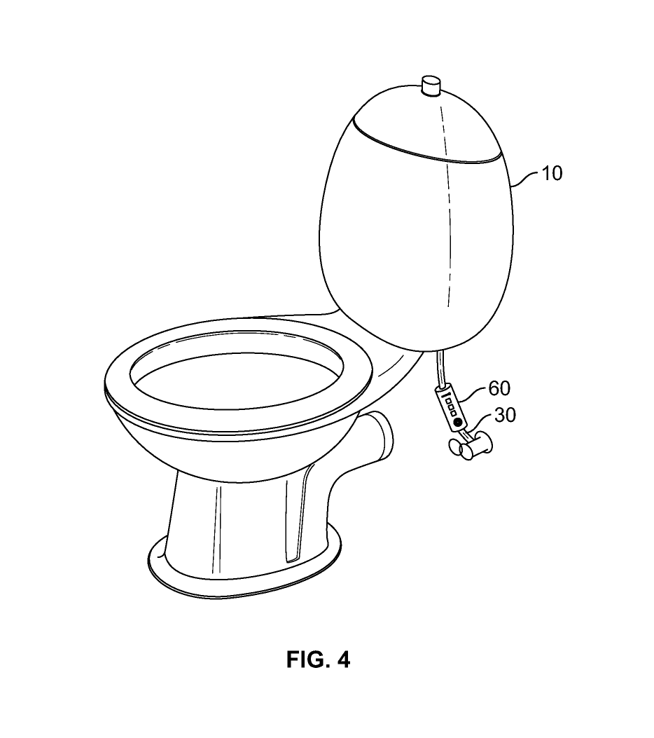

In reference to FIG. 3, a second Water Flow Monitor 60 is depicted. The Water Flow Monitor 60 is connected in line with a Water Supply Pipe 30. The Water Supply Pipe 30 is connected to a toilet at one end and at a water valve at a second end as shown in FIG. 4. The Water Supply Monitor 60 provides both an alarm and a mechanism to actually cut the water supply off should the overflow parameters are met associated with the Monitor 60. A Control Panel 40 is depicted in FIG. 3 along one side of the substantially cylindrical Monitor 40. The Monitor 40 includes three settings: a 8-minute overflow at 41a, a 10-minute flow setting 41b and a 12-minute flow setting 41c. Further a Reset Button 42 is also depicted on one side of the flow setting buttons. An Alarm 43 is provided that alerts the user of any potential excessive water flow.

The Flow Monitor 60 of the present invention is connected in line with the Water Supply Line 30 as shown for the Toilet 10 shown in FIG. 4. This Flow Monitor 60 applies both a shutoff mechanism where the water supply is shut off automatically and the alarm 43. This particular invention shuts the water off automatically should the water flow continue for the preset time periods provided. This flow monitors according to the present invention are very useful in preventing water waste and shuts off alarms for overflow and leakage associated with a toilet water supply. The instant invention has been shown and described in what it considers to be the most practical and preferred embodiments. It is recognized, however, that departures may be made there from within the scope of the invention and that obvious modifications will occur to a person skilled in the art.

What is claimed is:

1. A water flow monitor for detecting water flow comprising:
a. a control panel, where the control panel depicts control mechanisms associated with water flow monitoring;
b. a pipe receptacle on a bottom side of the water flow monitor;
c. a strap extending from the bottom, where the strap secures the water flow monitor to a water supply pipe;
d. a plurality of time period settings, where a particular time period may be selected using the control panel; and
e. an alarm, where the alarm alerts a user of continuous water flow over one of the time period settings.

2. The water flow monitor according to claim 1, where the plurality of time period settings include a 6-minute setting, a 8-minute setting and a 10-minute setting.

3. The water flow monitor according to claim 1, where the control panel includes a reset button.

4. A water flow monitor for detecting water flow comprising:
a. a control panel, where the control panel depicts control mechanisms associated with water flow monitoring;
b. a first connector, where the first connector connects to a water supply line;
c. a second connector, where the second connector connects to the water supply line;
d. an opening, where the opening enables the flow of water through the water flow monitor between the first connector and the second connector;
e. a plurality of time period settings, where a particular time period may be selected using the control panel;
f. an alarm, where the alarm alerts a user of continuous water flow over one of the time period settings; and
g. a shutoff mechanism, where the shutoff mechanism stops water flow through the water flow monitor.

5. The water flow monitor according to claim 4, where the plurality of time period settings include a 8-minute setting, a 10-minute setting and a 12-minute setting.

6. The water flow monitor according to claim 1, where the control panel includes a reset button.
